(19) United States
(12) Patent Application Publication
(10) Pub. No.: US 2015/0196905 A1
(43) Pub. Date: Jul. 16, 2015

(54) Centrifugable liquid vessel integrating a magnetic-bead separation-device

(71) Applicant: Robert Pinard, Andover, MA (US)

(72) Inventor: Robert Pinard, Andover, MA (US)

(21) Appl. No.: 14/153,820

(22) Filed: Jan. 13, 2014

(51) Int. Cl. B01L 3/00

(52) U.S. Cl. CPC B01L 3/508; B01L 2400/0409

(57) ABSTRACT

A centrifugable liquid vessel integrating a magnet in its lid and used for the separation of magnetic beads in suspension in a liquid. The device allows the separation of the magnetic beads and their efficient transfer or wash in the same or in a new vessel without the use of a pipetting device. The segregation, wash and transfer of the beads without aspiration significantly reduce the risks of contamination and maximize the magnetic beads recovery.

### CROSS-REFERENCE TO RELATED APPLICATIONS

This application claims the benefit of U.S. Provisional Application No. 61/752,521, filed Jan. 15, 2013, the entirety of which is hereby incorporated by reference.

### FIELD OF THE INVENTION

The present invention relates to the field of magnetic separation technique. Most specifically to the field of devices used for the separation of magnetic beads added to a biological sample such as, but not limited to, blood, bodily fluids, urine. More particularly, the invention relates to a device that combines the centrifugable liquid vessel and the magnetic separation apparatus in a single device.

### BACKGROUND OF THE INVENTION

Magnetic separation is a well documented and commonly used technique for purification or separation of various components of liquid sample like blood. Impurities or molecules of interest in suspension in a liquid can be separated via specific or non specific interactions of the component that need to be isolated using para-magnetic beads The beads are coated with biologic material, proteins or DNA that can interact specifically with a molecule or series the molecules that needs to be isolated from a liquid sample. The beads respond to a magnetic field which causes their migration towards the source and their concentration at this point of origin. This allows for a rapid and efficient separation of the bound material from the rest of the liquid sample. Unbound material is removed in the majority of the cases by aspiration, and the remaining bead-bound target is washed by the use of an external magnet. The bead-bound targets are then re-suspended in a small liquid volume for downstream applications. At this stage the target molecules can be released from the beads or used directly while still attached to the beads. Several magnet devices have been described for example the Dynal separator manufactured by Dynal, Inc or the BioMag separator from Perceptive Diagnostics. Magnetic separation devices have been described in U.S. Pat. No. 5,976,369 and U.S. Pat. No. 4,895,650. These devices employ permanent magnets located externally to the vessel containing the liquid of interest and the magnetic beads. The apparatus typically used to carry out this well documented process consists of a rack with a series of openings each containing a magnet located at the bottom or the side and into which the tubes are inserted. Often the beads will be linked at this step to a molecule of interest that needs to be extracted from the heterogeneous solution. The liquid (supernatant) can be removed, without perturbing the pellet of beads by decanting or by using a pipetting device. Material is often lost due to the perturbation of the pellet and aspiration of the beads. Moreover, in most of the biologic applications, a series of washing steps including: beads re-suspension, magnetic segregation, liquid extraction, are performed multiple times increasing the risk of contamination and lost of magnetic beads, as described previously. In the majority of these processes, the magnetic devices or separators use magnets that are external to the actual vessel and therefore required the aqueous solution to be removed between each extractions or washes using a pipetting or aspiration device.

### SUMMARY OF THE INVENTION

The present invention is a liquid vessel that incorporates the magnetic field used for bead separation within its lid

The device consists of four detachable parts: a centrifugable liquid vessel with threaded fitting for a screwable lid, a small powerful removable magnet that is fitted to a non-centric cylindrical connector cap that is itself screwed to an opened lid adapter. The tube also possesses threaded fitting at the bottom allowing the magnet-adapter-lid to be screwed at bottom of the tube in order to store the isolated beads temporarily.

The unique design of the magnetic separation device allows for the quick separation and washes of the segregated particles by allowing the physical removal of the beads that have migrated inside the magnet-adapter-lid and by simply transferring the said lid to another tube rather than by the aspiration of the liquid inside the vessel.

The magnet-adapter-lid containing the segregated beads can be transferred to another tube that is filled with wash buffer or aqueous solution, eliminating the need for pipetting or aspiration between each steps of the separation of the washes. Moreover, since the supernatant does not have to be removed before fresh solution is added to the pelleted-magnetic beads, the wash solution or buffer can be pre-heated and maintained at constant temperature increasing the washing efficiency

In one embodiment, the lid of the described device possess a detachable magnet that allows the pelleted beads to be re-suspended into a liquid after purification.

In another embodiment, the centrifugable tube also possesses threads at the bottom, where the magnetic lid can be attached with or without pelleted magnetic beads in solution. This design allows for the liquid in the original vessel to be further process, for instance, DNA can be extracted from blood and the magnetic beads, labeled with a molecule that can serve as molecular tag, that can be stored temporarily at the bottom of the tube. The beads can be re-added to the purified DNA and therefore could serve, for example, as molecular sample identification tags for blood samples.

The process using this magnetic-bead separation-device does not required pipetting to re-suspend or to remove the supernatant which reduce significantly the risk of contamination and also maximize the recovery of the magnetic beads. In addition, by eliminating the need for external magnetic separation apparatus, the size of the vessel with a magnetic lid component can vary freely as it is a integral part of the vessel lid. Larger centrifugable vessels can therefore be used for large-scale purification and for protein purification and concentration

### BRIEF DESCRIPTION OF THE FIGURES

The features and advantages of the invention will be apparent from the following more detailed description of preferred embodiments of the invention, as illustrated in the accompanying drawings. The drawings are not necessarily to scale, emphasis instead being placed upon illustrating the principles of the invention.

FIG. 1 A front view of the separation device and a 3-D rendition of the magnet-adapter-lid components.

FIG. 2 is a front view of the preferred embodiments of the apparatus and the visual representation of the potential storage or placement of the magnet-adapter-lid at the bottom of the centrifugable tube

FIG. 3 is a visualization of segregated or pelleted magnetic particles on the top wall of the hollow connector cap.

FIG. 4 is a schematic representation of a complete magnetic bead separation-cycle.

FIG. 5 is a front view of an alternative version for a non-screwable lid microcentrifuge tube and a 3-D rendition of the magnet-lid components.

FIG. 6 is a representation of the liquid vessel with the magnetic-adapter-lid in an upright or inverted position

### DETAILED DESCRIPTION OF THE PREFERRED EMBODIMENTS

With reference to the accompanying figures, the invention is a centrifugable liquid vessel incorporating a magnetic lid and that is used for the separation of magnetic particles in suspension in a liquid. The tube incorporates within its lid a powerful and small magnet that can be removed from the lid-adapter to release micro beads. The fact that the overall circumference of the top part of the magnet-adapter-lid is in its largest section identical to the one found at the bottom of the vessel, allow for the device to be placed in an upright or inverted position during a centrifugation process.

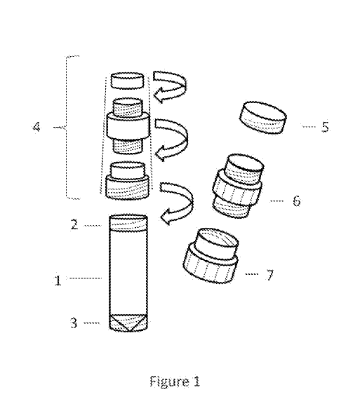

In FIG. 1, the separation device consist of: a centrifugable tube (1) and a magnet-adapter-lid component (4). Threads are found at the top of the tube to receive the lid (2) The interior wall of the hollow cylindrical portion located at the bottom and below the centrifugable tube also is grooved with screw threads to receive or store the magnet-adapter-component (3). The detailed design of the magnet-adapter-lid component is detailed in (5-7). It comprises essentially of: a screwable rubberized adapter containing a strong magnet (5), a cylindrical hollow connector cap (6) and opened lid-adapter (7). The hollow connector cap is closed at one extremity and includes dual threaded fittings allowing the attachment of the lid at one end and the adapter-magnet at the other end. The hollow connector cap is used to receive the segregated beads. The opened lid-adapter also includes dual threaded fittings, one fitting is located inside its narrow cylindrical portion to received the hollow cap connector as well as the within its wider portion for its fitting atop the centrifugable tube respectively.

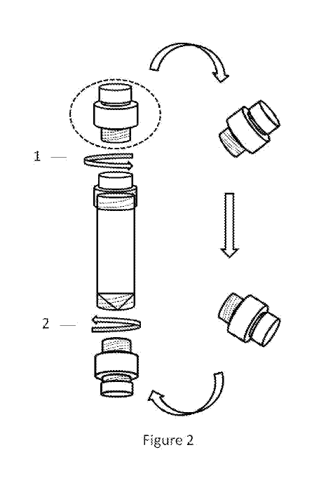

The embodiment of FIG. 2 shows that the top two section of the magnet-adapter-lid component comprising of the screwable magnet, as well as the cylindrical hollow connector cap can be positioned or temporarily stored at the top (1) or at the bottom of the centrifugable tube via a screw threaded hollow cylindrical extension located bellow the bottom of the tube (2).

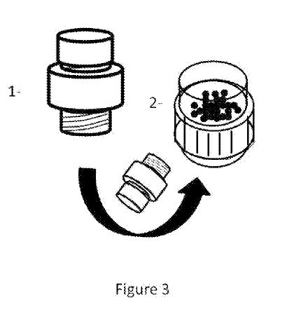

FIG. 3 shows the magnet-adapter-cap (1) and the area where the magnetic beads agglutinate in a pellet on the interior top wall of the cylindrical hollow connector cap (2).

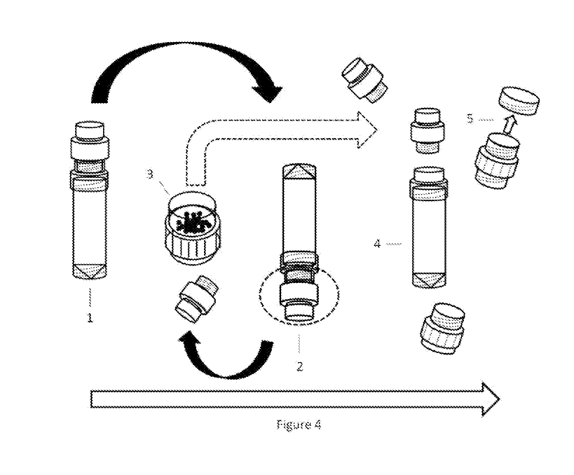

As described in FIG. 4, the removable magnet-adapter-lid allows the user to transfer the collected magnetic bead from one vessel to another without using aspiration devices to remove the supernatant. This design also allows for the quick transfer of the target-bound molecule to a new vessel reducing greatly the risk of contamination and material loss. In a typical process the para-magnetic beads and the biologic fluid are placed in a centrifugable tube with a magnet-adapter-lid (1). The separation device is inverted (2) and it is left upside down to allow the beads to converge towards the magnetic lid. The magnetic beads are segregated in the hollow connector cap (3). The tube is then placed in an upright position, spun briefly, if needed, and the magnetic-adapter-lid is removed (4). Finally, the magnet-adapter-lid is placed on a new centrifugable tube and the magnet is removed allowing the beads to be re-suspended in a new aqueous solution (5).

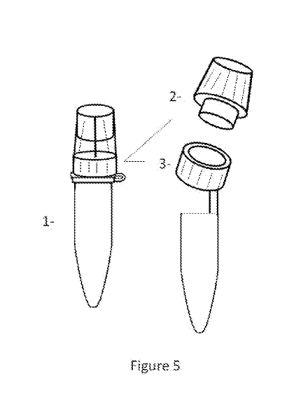

The embodiment of FIG. 5 shows an example how the magnet-adapter-lid can been adapted for a more conventional microcentrifuge tube. The conical shape found at both extremities allows for the centrifugation of the device in an inverted or upright position. In this case the design of the magnetic lid-adapter is less complex and is composed of two parts instead of three, a strong magnet covered with rubber material and having a protrusion to clip to the interior of the cylindrical hollow connector lid (3). In this case the magnetic-lid connector cannot be stored at the bottom.

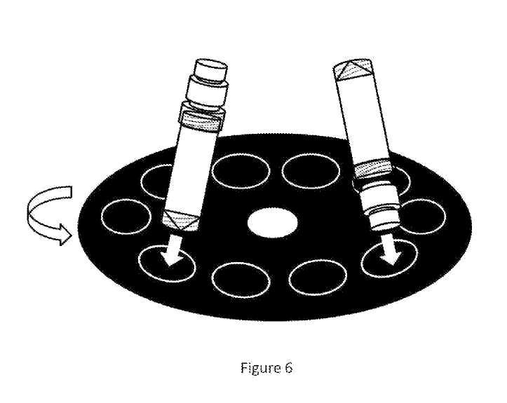

The embodiment of FIG. 6 shows how the liquid vessel with the magnetic-adapter-lid can be placed in a centrifuge in an upright or inverted position.

### CITATION LIST

### Patent Citations

| | Filing | Publication | | |
|---|---|---|---|---|
| Cited Patent | date | date | Applicant | Title |
| U.S. Pat. No. | Apr. 2, 1998 | Nov. 2, 1999 | Amersham | Magnetic |
| 5,976,369 | | | | separation |
| | | | | apparatus |
| U.S. Pat. No. | Feb. 25, 1988 | Jan. 23, 1990 | Gen-Probe | Magnetic |
| 4,895,650. | | | Inc | separation |
| | | | | rack for |
| | | | | diagnostic |
| | | | | assay |

The invention claimed is:

1. A centrifugable liquid vessel integrating a magnet in its lid and used for the separation of magnetic beads in suspension in a liquid and comprising of essentially four detachable components, a centrifugable liquid vessel, a small powerful removable magnet, a hollow cylindrical connector cap and an opened lid adapter.

2. Said the centrifugable liquid vessel of claim 1 possesses threaded fitting on the interior wall of the hollow cylindrical portion located at the bottom of the said vessel allowing the magnet-adapter with or without segregated magnetic beads to be screwed and stored underneath.

3. Said the centrifugable liquid vessel of claim 1 wherein the top and bottom circumferences are similar and possess a beveled shape allowing the device to be placed in an upright or inverted position during the centrifugation process.

4. Said the centrifugable liquid vessel of claim 1 wherein the uniform magnetic field is generated by at least one removable or permanent magnet in the lid of the vessel.

5. Said the centrifugable liquid vessel of claim 1 wherein the removable magnet component is composed essentially of an adapter with threaded fitting and a strong magnet

6. Said the centrifugable liquid vessel of claim 1 wherein the hollow cylindrical connector cap component is closed at one extremity and includes dual threaded fittings allowing the attachment of an opened lid-adapter at one end and the removable magnet at the other end.

7. Said the centrifugable liquid vessel of claim 1 wherein the opened lid-adapter component includes dual threaded fittings, one fitting located inside its narrow cylindrical portion to receive the hollow cylindrical cap connector and the other one within its wider portion for its fitting atop the centrifugable liquid vessel.
